(19) United States
(12) Patent Application Publication
(10) Pub. No.: US 2020/0189308 A1
(43) Pub. Date: Jun. 18, 2020

(54) Apparatus And Method For Remotely Recording And Compiling Personalized Messages

(71) Applicant: Alexander Fairchild Harding, Alexandria, VA (US)

(72) Inventor: Alexander Fairchild Harding, Alexandria, VA (US)

(21) Appl. No.: 16/221,051

(22) Filed: Dec. 14, 2018

(51) Int. Cl. B42D 15/02; G06Q 30/06; G07F 17/26

(52) U.S. Cl. CPC B42D 15/022; G07F 17/26; G06Q 30/0621

(57) ABSTRACT

The present disclosure relates to systems and methods which allow a user, or multiple users, to remotely record personalized greeting messages and deliver them to a centralized server, for example over the Internet. The centralized server may process one or more audio files and load the message, or combined messages, onto a personalized, physical item for an intended recipient.

### FIELD OF THE INVENTION

The present inventions relate to systems, methods, and apparatuses for loading personalized audio messages onto greeting cards or other memorabilia. More specifically, the inventions relate to remotely loading and sending personalized messages over a network. Aspects of the invention may accumulate multiple personalized messages and load the message onto a greeting card or other memorabilia.

### BACKGROUND OF THE INVENTION

The present inventions improve upon prior art devices and methods for loading personalized audio message onto greeting card or other memorabilia. Greeting cards, and other personalized memorabilia, are popular ways for people to stay in touch. Some prior art cards (or devices) include modules for playing back a personalized audio message. Although it is known to load a personalized message onto personalized objections such as greeting cards or other memorabilia, the prior art has multiple shortcomings. For example, Hallmark has developed a “Plush” recordable teddy bear which can be personalized with a message; however, Hallmark's device does not include advantages relating to how the message is recorded and loaded on to the memorabilia.

In the prior art devices, a user cannot record to the memorabilia remotely. Instead, users are only able to speak directly into the local storage (e.g. through a recording device such as a microphone) connected to the personalized object or memorabilia. This is disadvantageous, particularly in situations where it is desired to have a recording composed by multiple users. The prior art does not provide for remotely loading a recording, or for a user to review and/or edit the recording before loading it. Moreover, the prior art fails to disclose for the ability to remotely bill a user for a recording, or for the ability to have multiple users add to a recording. As such, the prior art further fails to disclose functionality for editing multiple recordings or rearranging multiple recordings before combining them into a single file and transferring it.

### BRIEF SUMMARY OF THE INVENTIONS

The present inventions relate to systems and methods for recording personalized greetings and loading them onto a personalized greeting card, or similar personalized memorabilia as described herein. Advantageously, the inventions provide the ability to record multiple personalized greetings from multiple locations, combine and edit the multiple personalized greetings, and then load the final product onto a greeting card. In this way, multiple family members are able to contribute and edit recordings, even when they are located in different physical locations.

Exemplary embodiments include a system for loading a personalize audio message onto an item of memorabilia, the system comprising a first and second client terminal, each having at least a user interface; a microphone; and a communications port; a central server having a processor, a memory, a database, and a first and second communications port; and an item of memorabilia, such as a greeting card, having at least a communication port, a memory, and a speaker, wherein the first and second client terminals are configured to record a first and second audio file using the respective microphones and send the first and second audio file, via the communications port, to the central server; and wherein the central server's processor is configured to store the first and second audio file in the memory, combined the first and second audio file into a single audio file; and load the single audio onto the item of memorabilia by connecting the second communications port to the communication port of the item of memorabilia.

In some embodiments, the first and second client terminal are located at remote physical locations. Additionally, the first and second client terminal's respective user interfaces may include a login screen, and wherein a user identification is associated with the respective first and second audio file and transmitted to the central server.

Moreover, the first and second client terminal's respective user interfaces may further receive an input for identifying an intended recipient, and at least the first or second client terminal's respective user interface can present a user with a display of the audio files associated with an intended recipient and allows a user to select an order for combining the audio files.

Additional embodiments disclose a method for loading a personalized greeting onto an item of memorabilia, comprising the steps of using a first client terminal, having a at least a user interface and a microphone, to enter a user's account information, using the first client terminal to identify an intended recipient, using the microphone of the first client terminal to record a first audio file, using the first client terminal to associate the intended recipient with the first audio file, delivering the first audio file and the associated intended recipient to a centralized server, the centralizer server having at least a processor, a memory, and a database; receiving, at the centralized server, at least a second audio file from a second client terminal and using the processor of the centralized server to combine the first and second audio file into a single audio file; and using a communications port to load the single audio file onto an item of memorabilia. The present inventions include the step of presenting a user, at the first client terminal, with a display containing billing options, and may also include the functionality for editing a recording.

### BRIEF DESCRIPTION OF THE DRAWINGS

FIG. 1 shows an exemplary system embodying the present inventions.

FIG. 2 shows exemplary hardware components of a client terminal.

FIG. 3 shows exemplary hardware components of a personalized object, such as a greeting card or other memorabilia.

FIG. 4 shows an exemplary user interface, presented for example on a touch screen, through which a user can practice embodiments of the inventions.

FIG. 5 shows an example of process steps taken by a client terminal.

FIG. 6 shows an example of process steps taken by a centralized server which receives audio recordings and delivers them to a greet card.

### DETAILED DESCRIPTION OF THE EMBODIMENTS

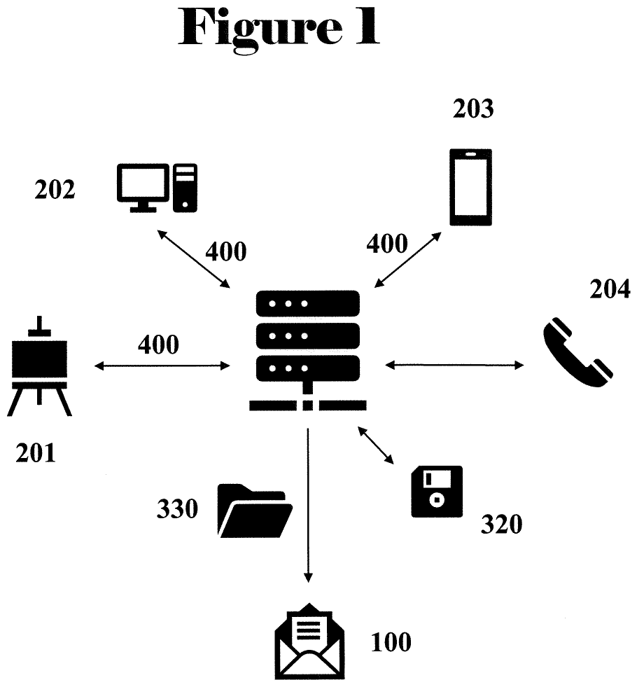

The present inventions include systems, methods, and apparatuses for loading personalized audio messages onto greeting cards or other memorabilia 100. As used herein, memorabilia 100 is intended to have a broad meaning, including for example a greeting card, stuffed animal, picture frame, or anything of the like. In FIG. 1, a greeting card is shown as an example onto which a personalized recording is loaded. However, a person of ordinary skill in the art would understand that the inventions apply equally to all forms of memorabilia, and nothing in this disclosure is intended to be limiting. Embodiments of the invention may include a client terminal 200, a centralized server 300, and an object containing a personalized greeting. Generally speaking, the inventions allow a user to access a client terminal 200 for recording a personalized message and sending such a message to a centralized server 300. The centralized server 300 receives the recorded messages, which may be sent from multiple locations. The server may further combine multiple messages into a single combined audio recording, and load that combined audio recording onto the greeting card, or other personalized object. Although the personalized object is a greeting card in some embodiments, it should be understood that the inventions also extend to personalizing other objects, such as stuffed animals or other memorabilia 100.

FIG. 1 shows an example of the system contemplated by the present inventions. Various client terminals 201, 202, 203, and 204 are shown in communication with a centralized server 300. It should be understood that references to client terminal 200 contemplate any of the embodiments shown in 201, 202, 203, and/or 204. In embodiments of the inventions, a user is able to use a client terminal 200 to record a personalized audio message which can be loaded onto a greeting card or other personalized memorabilia. The client terminal 200 may be a point-of-sale terminal (see e.g. 201), or a kiosk, positioned in a store or public location. In other embodiments, the client terminal 200 may include a software interface which can be loaded on a user's computer (202) or mobile device (203), as seen for example in FIG. 1. That is to say, as further described herein, embodiments of the invention include a software interface that can be access via the web, via mobile app, or via telephone (204).

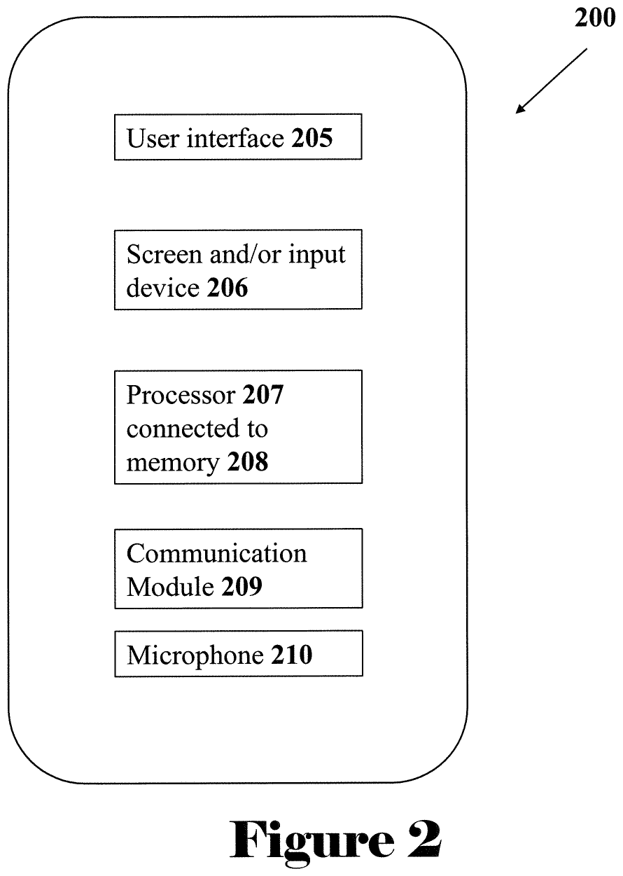

FIG. 2 shows an exemplary client terminal 200. In embodiments of the invention, client terminal 200 includes a user interface 205, a screen 206, a processor 207 connected to memory 208, a communications module 209, and a microphone 210.

The client terminal 200 may establish a connection to centralized server 300 using communication module 209. Communication module 209 communicates using known communications protocols, including wireless Internet connections, wired Internet connections, or any combination thereof. In some aspects of the inventions, the client terminal 200 may include a client interface 205. Client interface 205 may receive a user's username and password, optional photo, and verifying such username and password against a database provided on the centralized server 300. Other embodiments may allow a user to proceed on the client interface 205 on a “guest” basis which does not require an account to log in. Various exemplary devices which may be used as a client terminal are shown in FIG. 1, including a point of sale kiosk 201, a user's personal computer 202, a mobile device 203, or a telephone 204. The client interface 205 may be executed on a touch screen, or any other known input, such as a keyboard, and mouse.

The client terminal 200's interface, through a user input device 206, may further receive information about the intended recipient of the personalized greeting. The input device 206 may be a touch screen (for example, a screen displaying user interface 205), or it may take the form of a keyboard and/or mouse. The user inputs recipient information, where such recipient information may include the recipient's name, address, phone number, and any other relevant contact information. The client terminal 200's interface may also receive an optional photo, and/or written greeting. The recipient information is then conveyed over a network or over the Internet, to the centralized server 300.

In some embodiments, the centralized server 300 creates a profile for such intended recipient and responds to the client terminal 200 with a recipient code 350 which is unique to the intended recipient. Providing a unique recipient code 350 allows the user to stop and return to finish creating a personalized message at a later time. Moreover, the unique recipient code 350 is also used in scenarios where multiple users, at multiple locations, wish to create a combined greeting message. Each user provides the unique recipient code 350, which in turn allows the centralized server 300 to group messages intended for the same recipient.

Stated in plain terms, the unique recipient code 350 allows users to know and identify a person to whom a message is being sent. Thus, for example, multiple family members could identify their grandfather as an intended recipient. And, because their grandfather has a unique recipient code 350 associated with him, the centralized server 300 can understand that multiple recorded messages are intended for the grandfather, and subsequently combine them into a single recording, which is in turn loaded onto a greeting card and mailed to him. As mentioned above, this provides the benefit of not requiring each user to be in the same physical location.

Additional functionality of the inventions includes the ability for a user to send an “invitation” 360 to additional users to join a recording for an intended recipient. In such an embodiment, a user would select an “invite” button on the client interface 205. The client interface 205, communicating with the centralized server 300, receives the email address or mobile phone number for additional invited users and sends the invited users a message inviting them to join in recording a message for a given intended recipient. The invitation may take the form of email invitations to join a recording. The email invitation 360 includes a link (e.g. a URL), where the URL includes a reference to the specific intended recipient. Once activated, the URL allows the invited user(s) to make a recording (on their respective client terminals, e.g. a second client terminal 201, etc.), which is then delivered to the centralized server 300. In other embodiments, the invitation may be delivered via text message. And again, the centralizer server combines the multiple recordings into a single audio file for loading onto a device.

The client terminal 200 may further include a microphone 210 for receiving and recording audio from a user. As discussed above, in some embodiments, the microphone 210 may be on a user's computer or mobile device. In other embodiments, the microphone 210 may be built into a point-of-sale kiosk. Using the microphone 210, the client terminal 200 records audio and may store the audio in any known or proprietary format for audio recordings. The recording is then sent to the centralized server 300, together with an optional accompanying recipient code 350 for identifying the recipient for whom the recording is intended.

In yet another embodiment of the invention, the client terminal 200 may be a telephone or cellphone for dialing in the centralizer server. In such an embodiment, a user is not presented with a client interface 205 in the visual sense but is instead prompted (by voice commands) to make a recording. In such an embodiment where a user wishes to make a telephonic recording, the user may dial a telephone numbers (such as, 1-8000-123-4567) and enter a known pin, such as 1234. The pin is created randomly and is associated with the recipient account. The user is then prompted to record a voice message, similar to leaving a voicemail. The recorded message is delivered to the centralized server 300 for processing, according to the techniques described herein.

The centralized server 300 may be a single computer connected to a network or the Internet 400. In other embodiments, the centralized server 300 may be a known server device. Preferably, the centralized server 300 comprises a network or Internet connection 400, a processor connected to a memory, a database 320, and a connection for loading personalized messages onto objects. The database 320 may store, in the memory, information relating to users and recipient code 350. The processor, in turn, may be used to group audio messages intended for the same recipient.

That is to say, the inventions enable multiple users at multiple locations to record messages intended for the same recipient. Audio messages are associated with a unique recipient code 350, and the processor may first group all the messages intended for one recipient, and subsequently combine the audio files into one single file 330, which is subsequently loaded onto a greeting card or other memorabilia 100.

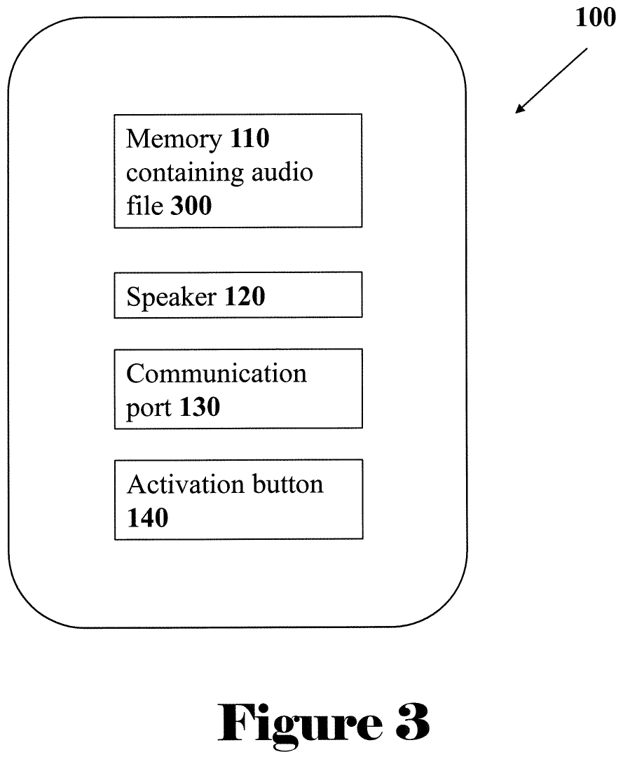

The single (combined) audio file 330 is then loaded onto the personalized object (another way of saying, loaded onto the memorabilia 100). The personalized object (memorabilia 100) is shown in FIG. 3. It may include computer hardware which is embedded in a physical object (for example, attached inside a greeting card), including a port 130 for connecting to the centralized server 300, a memory 110 for storing an audio file, and a speaker 120 for playing the audio file. Alternatively, audio may be loaded wirelessly, for example using the Bluetooth protocol or any other know wireless communication protocol. The hardware may further include a switch or button 140 to begin playing the audio file, either manually (at the recipient's request) or automatically (for example, when a greeting card is opened).

The centralized server 300 may connect to the personalized object via any known communication port, including, for example, AUX, USB, USB-C, or RS232. Wireless connections are likewise contemplated by the present inventions. Once the centralized server 300 and the object's hardware have established a connection, the audio file 330 is transferred to the object. Then the object, with the audio file 330 now transferred to it, may be installed inside a greeting card, stuffed animal, or any other memorabilia, and sent via mail, or otherwise delivered, to the recipient. In this way, audio is first recorded by the consumer, transferred to the centralized server 300 via the Internet 400 or other connection, combined with any additional recordings (as appropriate), and then transferred to the module (in the object).

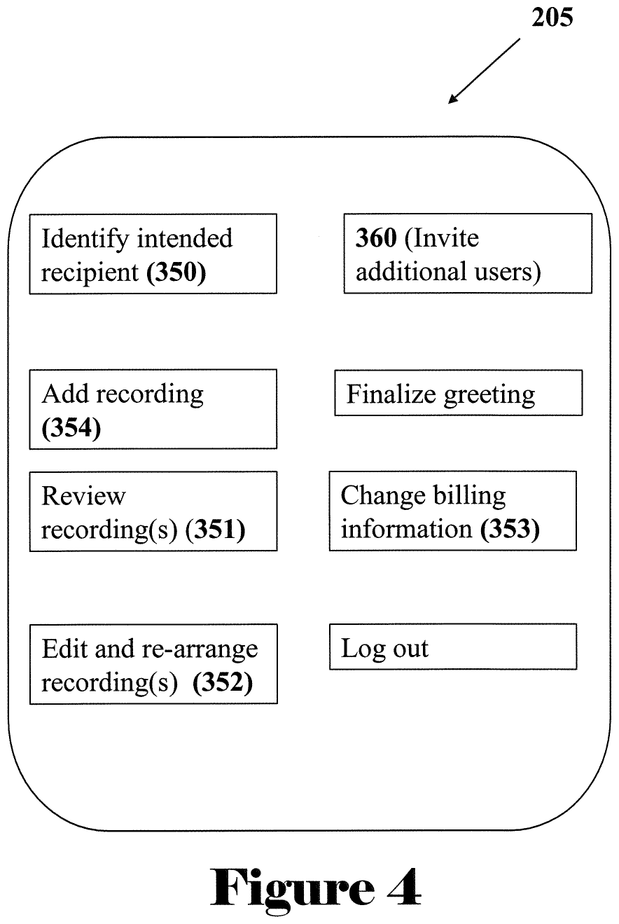

Some embodiments of the inventions provide additional features in the client interface 205. An exemplary user interface 205 is shown in FIG. 4. In the example of FIG. 4, the client interface 205 is presented on a touch screen, allowing for user selection of various buttons. For example, the client interface 205 may communicate with the centralized server 300 to determine how many recordings have been submitted for a given recipient code 350, and then display the user information associated with each of the recordings. By selecting the interface's button 351 or 354, a user can review existing recordings and/or add additional recordings. A user many then re-arrange the order of the recordings and/or edit the length of the recordings. To that end, exemplary button 352 is provided for editing and/or re-arranging existing recordings. The “edit” functionality may include the ability for a user to select music to overlay over a voice recording, where such music is proceeded by server 300 to play over a voice recording.

Additional aspects of interface 205 include presenting the user with payment options. For example, the client interface 205, together with the centralized server 300, may also handle billing. In such embodiments, a user may be presented with various payment options, for example via button 353. Use of the client interface may be conditioned on payment. Payment can be made via a gift card, or through any know payment processing system, including, without limitation, known credit cards such as Visa or Mastercard. In some embodiments, payment may be based on the length of a recording (either alone, or for all users combined) or payment may be based on the number of users who will contribute audio recordings to a given recipient code. The payment may also cover the cost of memorabilia 100, for example, the cost of a greeting card plus the cost of delivering such a card.

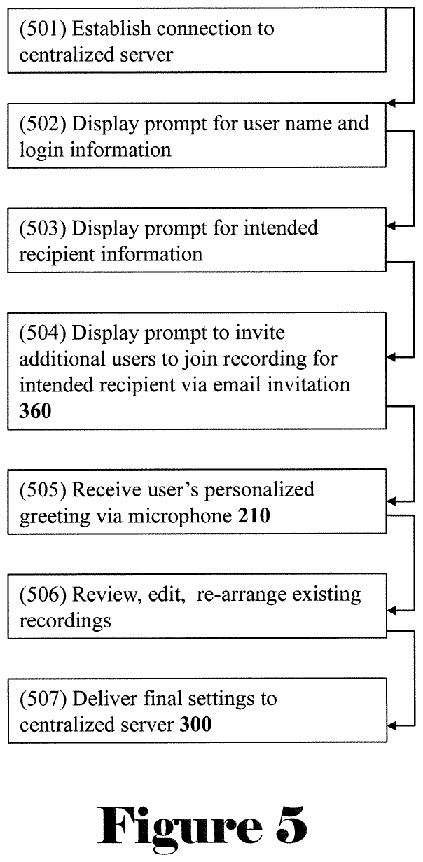

To illustrate an example using FIG. 5, a user may be creating a personalized greeting card for a family member living in another city or country. FIG. 5 shows an exemplary flow chart of steps of the invention executed at the client terminal 200.

The user may log into the client interface 205 and create an audio recording, which is submitted to the centralized server 300 via a connection established at 501. Additional friends or family members may also wish to add an audio recording to the greeting card at 504. Embodiments of the inventions enable such additional users to also log into the client interface 205 (from any location) and add their own audio recording associated with the unique recipient code 350.

The user may then select billing options which are presented via interface 205. Next, at 505, the user may use a microphone 210 to record a greeting and send that recording to centralized server 300. At 506, the user reviews and/or edits a recording, and may further re-arrange recording in scenarios where multiple users have contributed recordings. Once completed, the user finalizes the greeting at 507 and delivers it to the centralized server 300.

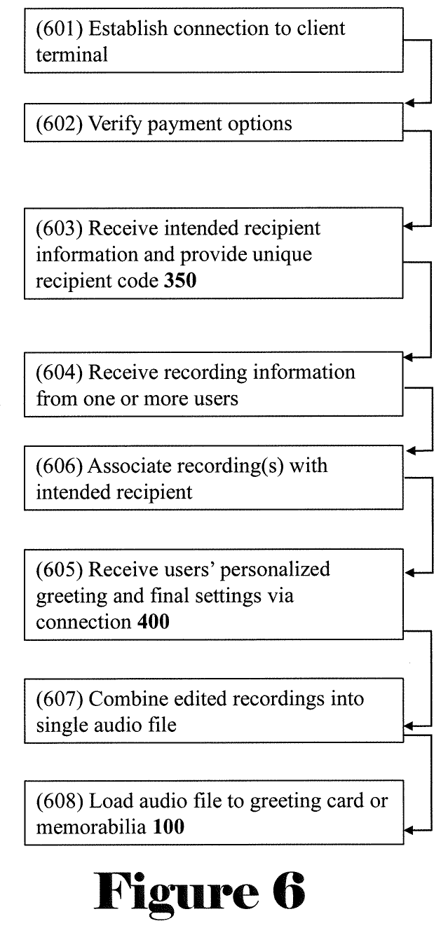

FIG. 6 shows an exemplary flow chart of processes executed at the centralized server 300. As discussed herein, centralized server 300 establishes a connection 601 to client terminal and may verify payment options, for example at 602. It should be understood that the present invention contemplates that the various steps may be performed in different orders. Thus, for example, payment may be verified at the beginning of the process, at the end, or at any other time.

Centralized server 300 receives information about an intended recipient 603 from a client terminal 200, and may respond with a unique recipient code 350. The recipient code 350 may be used to enable multiple users at multiple locations to associate a recording with the same intended recipient. In this way, multiple users can record greetings and deliver them to centralized server 300 as seen at step 604. If a user intends to re-arrange or edit recordings, those settings are delivered at step 605. Regardless of how a user edits or arranges recordings, once the recordings are finalized, at 607, centralized server combines the recordings into a single audio file and loads them to a greeting card (or other memorabilia 100) at 608.

The above description is not intended to limit the meaning of the words used in or the scope of the following claims that define the invention. Rather the descriptions and illustrations have been provided to aid in understanding the various embodiments. It is contemplated that future modifications in structure, function or result will exist that are not substantial changes and that all such insubstantial changes in what is claims are intended to covered by the claims. Thus, while preferred embodiments of the present inventions have been illustrated and described, one of skill in the art will understand that numerous changes and modifications can be made without departing from the claimed invention. In addition, although the term “claimed invention” or “present invention” is sometimes used herein in the singular, it will be understood that there are a plurality of inventions as described and claimed.

Various features of the present inventions are set forth in the following claims.

1. A system for loading a personalized audio message onto an item of memorabilia, the system comprising:
at least a first and second client terminal, having a first and second user interface, respectively; a microphone; and a communications port;
a central server having a processor, a memory, a database, and a first and second communications port; and
an item of memorabilia, having at least a communication port, a memory, and a speaker;
wherein the first and second client terminals are configured to record a first and second audio file using the respective microphones and send the first and second audio file, via the communications port, to the central server;
wherein the central server's processor is configured to store the first and second audio file in the memory, combine the first and second audio file into a single audio file; and load the single audio onto the item of memorabilia by connecting the second communications port to the communication port of the item of memorabilia,
wherein at least the first user interface includes a button for selecting payment options for making a payment, the payment depending on the number of audio files combined at the central server, the length of the combined single audio file, and the cost of the item of memorabilia.

2. The system of claim 1, wherein the first and second client terminal are located at remote physical locations.

3. The system of claim 2, wherein the first and second client terminal's respective user interfaces include a login screen, and wherein a user identification is associated with the respective first and second audio file and transmitted to the central server.

4. The system of claim 3, wherein the first and second client terminal's respective user interfaces further receive an input for identifying an intended recipient.

5. The system of claim 4, wherein at least the first or second client terminal's respective user interface presents a user with a display of the audio files associated with an intended recipient and allows a user to select an order for combining the audio files.

6. A method for loading a personalized greeting onto an item of memorabilia, comprising the steps of:
using a first client terminal, having a at least a user interface and a microphone, to enter a user's account information;
using the first client terminal to identify an intended recipient;
using the microphone of the first client terminal to record a first audio file;
using the first client terminal to associate the intended recipient with the first audio file;
delivering the first audio file and the associated intended recipient to a centralized server, the centralizer server having at least a processor, a memory, and a database;
receiving, at the centralized server, at least a second audio file from a second client terminal and using the processor of the centralized server to combine the first and second audio file into a single audio file;
using a communications port to load the single audio file onto an item of memorabilia; and
displaying on the user interface of the first client terminal a plurality of payment options for making a payment, wherein payment depending on the number of audio files combined at the central server, the length of the combined single audio file, and the cost of the item of memorabilia.

7. (canceled)

8. The method of claim 7, further comprising the step of presenting a user, at the user interface, with the option to edit a recording.

9. The system of claim 1, wherein the payment options include a gift card or a credit card.

10. The system of claim 9, wherein the central server is further configured to accept payment as a condition to combining the first and second audio file into a single audio file.

11. The method of claim 6, wherein the payment options include a gift card or a credit card.

12. The method of claim 11, wherein the step of loading the single audio file onto an item of memorabilia is conditioned upon receiving payment through the user interface.
